(19) United States
(12) Patent Application Publication
(10) Pub. No.: US 2001/0017756 A1
(43) Pub. Date: Aug. 30, 2001

(54) Method of and circuit for protection against overcurrent

(76) Inventor: Moritaka Iyoda, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/791,747

(22) Filed: Feb. 26, 2001

(30) Foreign Application Priority Data
Feb. 28, 2000 (JP) 2000-050747

(51) Int. Cl. H02H 9/00

(52) U.S. Cl. 361/58; 361/93.9

(57) ABSTRACT

A hot-line inserting and removing apparatus is capable of inserting and removing a circuit unit while the apparatus is in operation. An overcurrent protection circuit is inserted in a power supply in the hot-line inserting and removing apparatus, and has a switch which changes its resistance to prevent a rush current from flowing into a capacitive component of a connected load for protection against an overcurrent at the time the circuit unit is inserted.

### BACKGROUND OF THE INVENTION

1. Field of the Invention

The present invention relates to a method of and a circuit for protection against an overcurrent, and more particularly to a method of and a circuit for protection against an overcurrent in a hot-line inserting and removing apparatus which is capable of inserting and removing a circuit unit while the apparatus is in operation.

2. Description of the Related Art

There has heretofore been known in the art an overcurrent protection circuit in a hot-line inserting and removing apparatus which is capable of inserting and removing a circuit unit while the apparatus is in operation. When an abnormal load represented by a current which exceeds an overcurrent detection level over a preset masking time is detected, the overcurrent protection circuit judges the situation as an abnormal state, and performs a protective action to turn off a switch or the like based on the judgement.

FIG. 1 of the accompanying drawings illustrates a concept of the arrangement of conventional hot-line inserting and removing apparatus 1. As shown in FIG. 1, conventional hot-line inserting and removing apparatus 1 has power supply circuit 2 and overcurrent protection circuit 3 inserted in a power supply line. While the apparatus is in operation, circuit unit 4 which is equivalently expressed by a load of L, C, and R can be inserted and removed. Overcurrent protection circuit 3 comprises switch 3a and resistor 3b.

FIG. 2 of the accompanying drawings is a graph showing a rush current in hot-line inserting and removing apparatus 1 shown in FIG. 1. The graph has a horizontal axis representing time and a vertical axis a current. As shown in FIG. 2, when circuit unit 4 is inserted and connected to hot-line inserting and removing apparatus 1 at time t0, rush current i is generated. If rush current i exceeds overcurrent detection level L over preset masking time T, switch 3a of overcurrent protection circuit 3 is turned off at time t1 when masking time T elapses. Circuit unit is now protected, and rush current i does not flow.

If capacitance (C) of circuit 4 is larger than expected, then the period of time in which rush current i is generated is prolonged. When the prolonged period of time reaches masking time T, then the situation is judged as an abnormal load. In order to prevent the situation from being judged as an abnormal load, it is necessary to increase masking time T.

If masking time T is increased, however, when an abnormal load nearly equivalent to a short circuit is connected to hot-line inserting and removing apparatus 1, it supplies as large a current as possible during increased masking time T. Therefore, device breakdowns due to the concentration of a current on overcurrent protection circuit 3 and the melting of gold wires used therein are caused, with the result that power supply circuit 2 is broken.

### SUMMARY OF THE INVENTION

It is therefore an object of the present invention to provide a method of and a circuit for protection against an overcurrent in a hot-line inserting and removing apparatus, for preventing an erroneous abnormal load from being detected due to a rush current and also protecting a power supply circuit from being broken when a real abnormal load is connected.

To achieve the above object, there is provided in accordance with the present invention a method of protection against an overcurrent which is generated when a circuit unit is inserted and connected to a hot-line inserting and removing apparatus which is capable of inserting and removing the circuit unit while the apparatus is in operation, comprising the step of changing the resistance of switch means inserted in a power supply line of the apparatus in order to prevent a rush current from flowing into a capacitive component of a connected load for thereby protecting the apparatus against an overcurrent.

With the above arrangement, the resistance of the switch means inserted in the power supply line of the apparatus is changed in order to prevent a rush current from flowing into the capacitive component of the connected load for protection against an overcurrent that is generated when the circuit unit is inserted and connected while the apparatus is in operation. Thus, the detection of an erroneous abnormal load due to the rush current is prevented, and a power supply circuit is protected against breakdown when a real abnormal load is connected.

The above method can be carried out by an overcurrent protection circuit.

The above and other objects, features, and advantages of the present invention will become apparent from the following description based on the accompanying drawings which illustrate an example of an embodiment of the present invention.

### BRIEF DESCRIPTION OF THE DRAWINGS

FIG. 1 is a block diagram illustrating a concept of the arrangement of a conventional hot-line inserting and removing apparatus;

FIG. 2 is a graph showing a rush current in the hot-line inserting and removing apparatus shown in FIG. 1;

FIG. 3 is a block diagram illustrating a concept of the arrangement of a hot-line inserting and removing apparatus having an overcurrent protection circuit according to an embodiment of the present invention;

FIG. 4 is a block diagram showing specific details of the overcurrent protection circuit shown in FIG. 3; and

FIG. 5 is a graph showing a rush current in the hot-line inserting and removing apparatus shown in FIG. 3.

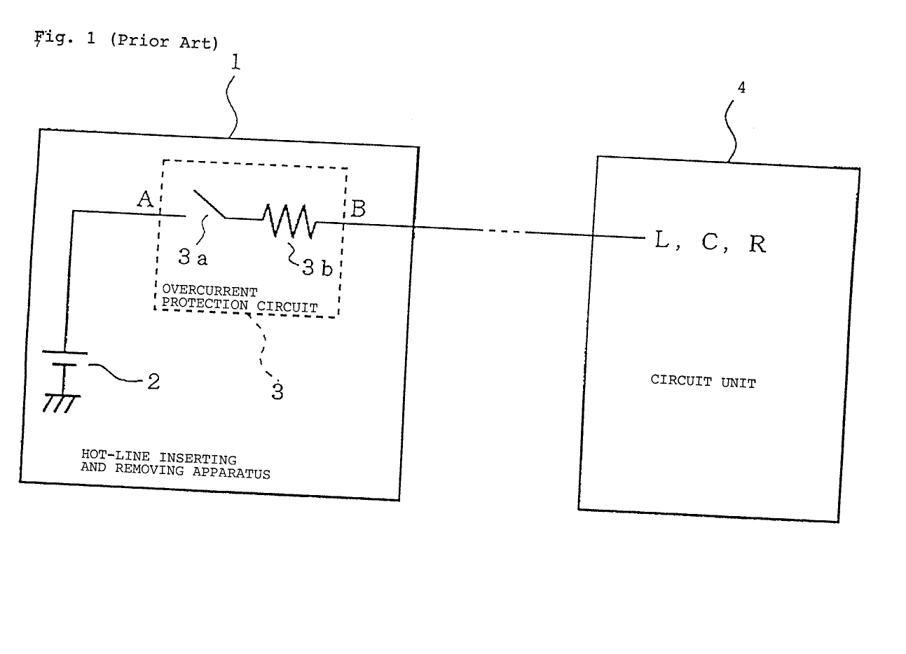

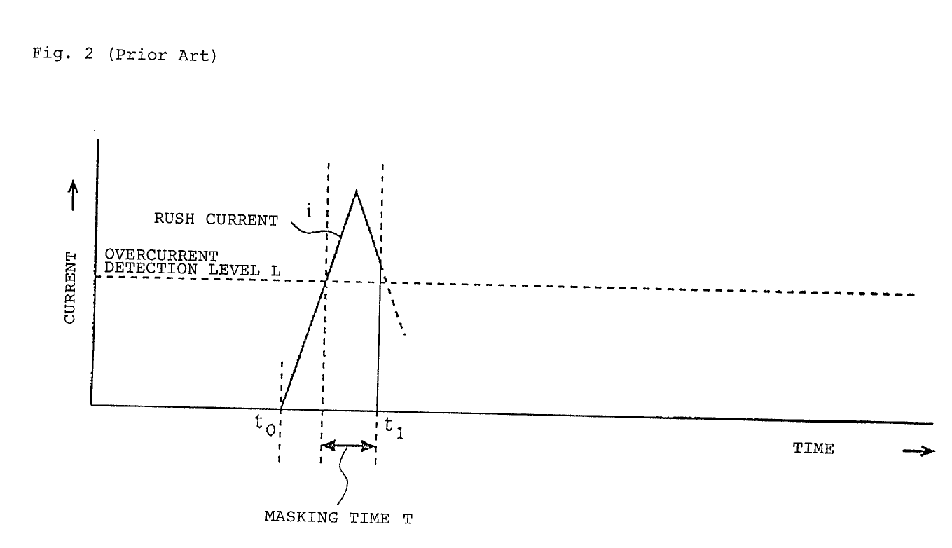

### DETAILED DESCRIPTION OF THE PREFERRED EMBODIMENT

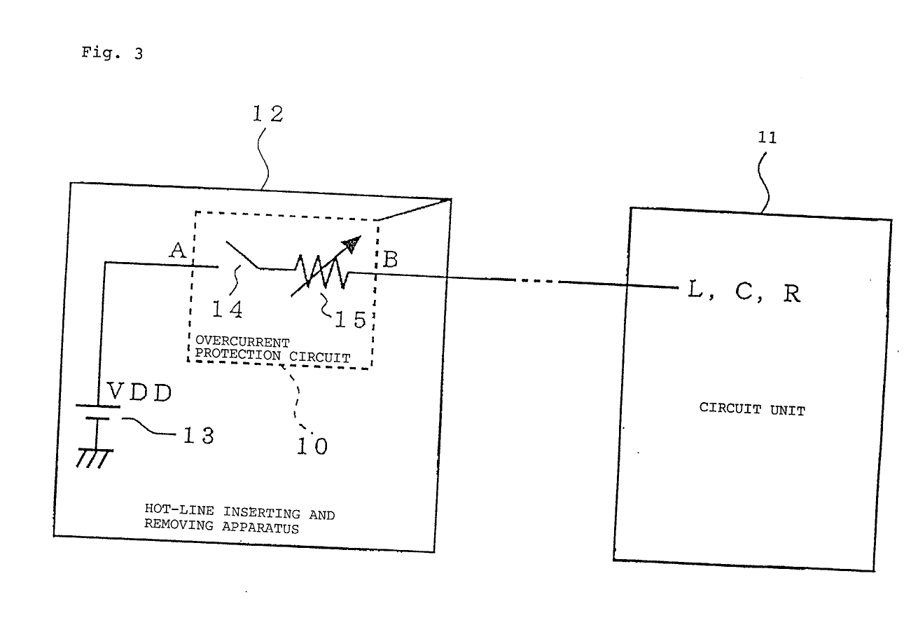

FIG. 3 illustrates in block form a concept of the arrangement of hot-line inserting and removing apparatus 12 having an overcurrent protection circuit according to an embodiment of the present invention. As shown in FIG. 3, hot-line inserting and removing apparatus 12 allows circuit unit 11, which is equivalently expressed by a load of L, C, and R, to be inserted and removed while the apparatus is in operation. Hot-line inserting and removing apparatus 12 has overcurrent protection circuit 10 inserted in a power supply line from power supply circuit 13.

Overcurrent protection circuit 10 has a switch (switch means) 14 having a variable resistor 15. When overcurrent protection circuit 10 detects an abnormal load represented by a current flowing in excess of an overcurrent detection level over a preset mask time, overcurrent protection circuit 10 judges the situation as an abnormal state, and performs a protective action to turn off the switch 14 thus breaking power supply circuit 13 based on the judgement.

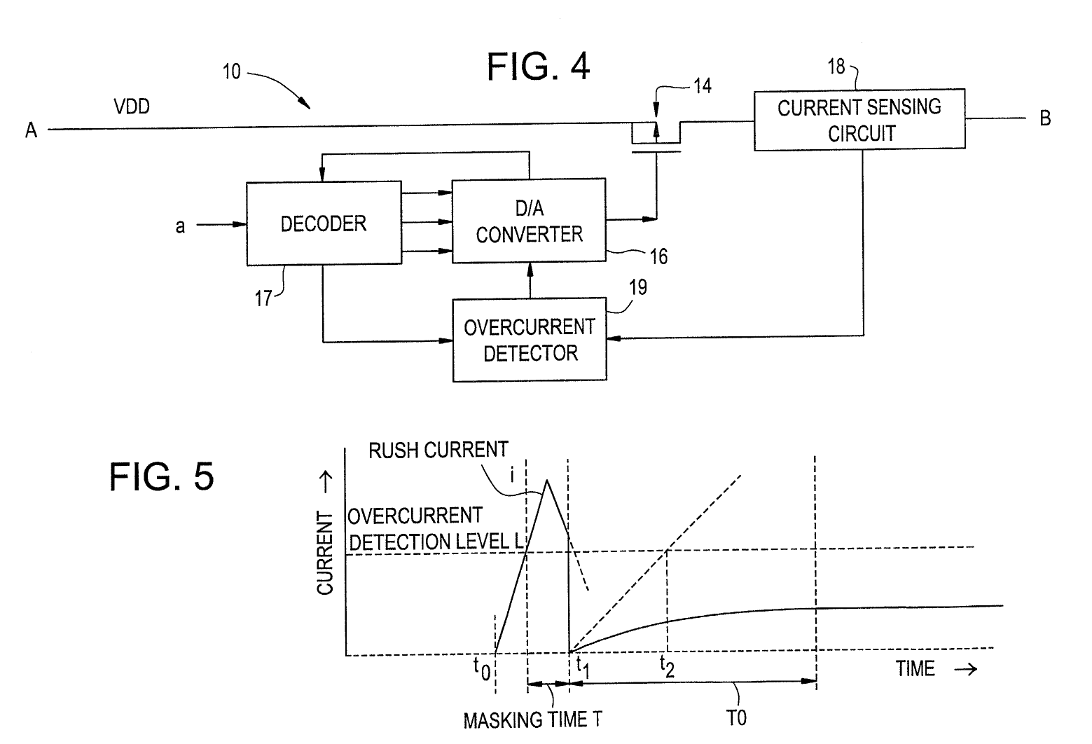

FIG. 4 shows in block form specific details of overcurrent protection circuit 10 shown in FIG. 3.

As shown in FIG. 4, overcurrent protection circuit 10 comprises switch 14, D/A converter 16, decoder 17, current sensing circuit 18, and overcurrent detector (overcurrent detecting means) 19.

Switch 14 comprises a semiconductor device such as a MOSFET (metal oxide semiconductor field-effect transistor), such as a P-channel MOSFET (hereinafter referred to as “PchMOS”). Variable resistor 15 represents the resistance of the semiconductor device, and the resistance changes from a low resistance to a high resistance.

D/A converter 16 is connected to the gate of PchMOS 14. D/A converter 16 outputs a voltage ranging from a power supply voltage (VDD) to a ground potential (GND).

Decoder 17 converts a reference clock signal a to a parallel signal to drive D/A converter 16. An output (gate voltage of the PchMOS) of D/A converter 16 represents a voltage value which decreases from VDD to GND as clock signal a changes.

When the output from D/A converter 16 drops to GND, D/A converter 16 outputs a control signal to decoder 17. Subsequently, decoder 17 is de-energized even when clock signal a changes, and the output (gate voltage of the PchMOS) of D/A converter 16 is kept at GND. Therefore, PchMOS 14 is fully turned on, and such a state serves as a steady state of the circuit.

Current sensing circuit 18 for detecting a current flowing through PchMOS 14 is connected between the drain of PchMOS 14 and terminal B of overcurrent protection circuit 10.

Current sensing circuit 18 monitors the output current from PchMOS 14 at all times. A current detected signal from current sensing circuit 18 and an output signal from decoder 17 are applied to overcurrent detector (overcurrent detecting means) 19, which outputs an overcurrent detected signal to D/A converter 16.

FIG. 5 is a graph showing a rush current in the hot-line inserting and removing apparatus shown in FIG. 3.

The graph has a horizontal axis representing time and a vertical axis a current. As shown in FIG. 5, when circuit unit 11 is inserted and connected to hot-line inserting and removing apparatus 12 at time t0, rush current i is generated from time t0. If rush current i exceeds overcurrent detection level L over preset masking time T, variable resistor 15 of overcurrent protection circuit 10 is set to a high resistance at time t1 when masking time T elapses. Then, as time T0 elapses, the resistance of variable resistor 15 is progressively lowered.

Operation of overcurrent protection circuit 10 when a load is connected thereto will be described in detail below with respect to a situation where the load is normal load and a situation where the load is an abnormal load. The output from D/A converter 16 is kept at GND, and the resistance of PchMOS 14 is extremely low.

(1) When a normal load is connected:

When the load is connected, rush current i flows to the load. Generally, rush current i has a peak value which is represented by a large current of several amperes. Rush current i is monitored by current sensing circuit 18. If the value of rush current i exceeds overcurrent detection level L set by overcurrent detector 19, then overcurrent detector 19 starts measuring time to determine whether an overcurrent due to rush current i is detected or not. If the time in which the value of rush current i is higher than overcurrent detection level L is smaller than the preset mask time T, then no problem arises. Depending on the magnitude of the capacitive component of the load, rush current i in excess of overcurrent detection level L may possibly flow over masking time T .

At this time, with the circuit arrangement of overcurrent protection circuit 10, a signal is transmitted from overcurrent detector 19 via D/A converter 16 to decoder 17, from which clock signal a is transmitted to D/A converter 16. The output of D/A converter 16 changes from GND to VDD, and thereafter decreases to GND as clock signal a changes. After PchMOS 14 is temporarily turned off, the resistance thereof is reduced. Therefore, while the resistance of the switch, i.e., the resistance of the variable resistor 15, is changing, a charging current for the capacitive component of the load is suppressed (Refer FIG. 5).

(2) When an abnormal load is connected:

For example, the load is short-circuited. PchMOS 14 is temporarily turned off by rush current i, as is the case with the connection of the normal load described above. However, as the resistance of PchMOS 14 changes, the current flowing through the load increases. At certain time t2, the current flowing through the load exceeds overcurrent detection level L again. At this time, the resistance of the switch, i.e., the variable resistor 15, limits the current to protect the power supply circuit when the current exceeds overcurrent detection level L.

That is, overcurrent protection circuit 10 first keeps the switch turned off to break the power supply circuit if a current in excess of overcurrent detection level L is detected during the time in which the output potential of D/A converter 16 changes from VDD to GND. Consequently, the overcurrent protection circuit is capable of breaking the power supply circuit only when an abnormal load is connected.

According to the present invention, as described above, if rush current i generated when a load is connected exceeds a detection level over preset masking time T in overcurrent protection circuit 10, then the switch (PchMOS14) inserted in the power supply line is temporarily set to a high resistance. Thereafter, the resistance of the switch is changed to a low value with time.

In this manner, rush current i flowing into the capacitive component of the load is prevented. When a real abnormal load is connected, the current is initially limited by the resistance of the switch. When the current exceeds overcurrent detection level L again as the resistance drops, the system recognizes an abnormal state.

With the conventional system, the protection circuit detects an erroneous abnormal load if the rush current generated when a load is connected exceeds the overcurrent detection level of the protection circuit which is monitoring the state of the output current. However, overcurrent protection circuit 10 according to the present invention is capable of preventing the detection of an erroneous abnormal load due to the rush current, and can protect the power supply circuit against breakdown when a real abnormal load is connected.

The masking time T set by the protection circuit can be set to a minimum value required, because rush current i is limited by the resistance of the switch as the resistance of the switch is temporarily changed to a high value and then to a low value. When the load is short-circuited due to an abnormal load, the power supply circuit can also be protected against breakdown, because the current as it is limited by the resistance of the switch exceeds the overcurrent detection level, so that the device breakdowns due to the concentration of a current on the device and the melting of gold wires used therein are prevented from being caused.

According to the present invention, as described above, the resistance of the switch means inserted in the power supply line of the apparatus changes to prevent a rush current flowing into the capacitive component of the connected load to protect the power supply circuit against an overcurrent that is generated when a circuit unit, which can be inserted and removed while the apparatus is in operation, is inserted and connected. Thus, an erroneous abnormal load is prevented from being detected due to a rush current, and the power supply circuit is protected against breakdown when a real abnormal load is connected.

The overcurrent protection circuit according to the present invention can carry out the above overcurrent protection method.

It is to be understood, however, that although the characteristics and advantages of the present invention have been set forth in the foregoing description, the disclosure is illustrative only, and changes may be made in the arrangement of the parts within the scope of the appended claims.

What is claimed is:

1. A method of protection against an overcurrent which is generated when a circuit unit is inserted and connected to a hot-line inserting and removing apparatus which is capable of inserting and removing the circuit unit while the apparatus is in operation, comprising the step of:
changing the resistance of switch means inserted in a power supply line of the apparatus in order to prevent a rush current from flowing into a capacitive component of a connected load for thereby protecting the apparatus against an overcurrent.

2. A method according to claim 1, wherein the resistance of said switch means changes temporarily to a high value and then to a low value with time.

3. A method according to claim 2, wherein the resistance of said switch means changes if said rush current exceeds an overcurrent detection level over a preset masking time.

4. A method according to claim 3, wherein if said rush current increases from a limited state and exceeds said overcurrent detection level again as the resistance of said switch means changes, then the situation is judged as the connection of an abnormal load and a power supply circuit is broken.

5. A circuit for protection against an overcurrent which is generated when a circuit unit is inserted and connected to a hot-line inserting and removing apparatus which is capable of inserting and removing the circuit unit while the apparatus is in operation, comprising:
switch means inserted in a power supply line of the apparatus, for changing a resistance in order to prevent a rush current from flowing into a capacitive component of a connected load.

6. A circuit according to claim 5, wherein the resistance of said switch means changes temporarily to a high value and then to a low value with time.

7. A circuit according to claim 6, wherein the resistance of said switch means changes if said rush current exceeds an overcurrent detection level over a preset masking time.

8. A circuit according to claim 7, wherein if said rush current increases from a limited state and exceeds said overcurrent detection level again as the resistance of said switch means changes, then the situation is judged as the connection of an abnormal load and a power supply circuit is broken.

9. A hot-line inserting and removing apparatus which is capable of inserting and removing a circuit unit while the apparatus is in operation, comprising a circuit for protection against an overcurrent according to claim 5, said circuit being inserted in the power supply line.
